(19) United States
(12) Patent Application Publication
(10) Pub. No.: US 2018/0207734 A1
(43) Pub. Date: Jul. 26, 2018

(54) CUTTING TOOL

(71) Applicant: Charlie ZHANG, Oak Brook, IL (US)

(72) Inventor: Charlie ZHANG, Oak Brook, IL (US)

(21) Appl. No.: 15/877,446

(22) Filed: Jan. 23, 2018

Related U.S. Application Data
(60) Provisional application No. 62/449,316, filed on Jan. 23, 2017.

(51) Int. Cl. B23D 35/00; B23D 15/04

(52) U.S. Cl. CPC B23D 35/005; F16M 11/08; B23D 15/04

(57) ABSTRACT

A portable, non-power operated cutting tool for cutting siding materials in a straight fashion without splintering or cracking. The cutting tool including a base with a cutting platform rotably connected to the base allowing the cutting platform to be set to cut siding at a range of angles from 0° to 180°.

### CROSS REFERENCE TO RELATED APPLICATION

This application claims the benefit of U.S. Provisional Patent Application, Ser. No. 62/449,316, filed on 23 Jan. 2017. The co-pending Provisional Application is hereby incorporated by reference herein in its entirety and is made a part hereof, including but not limited to those portions which specifically appear hereinafter.

### BACKGROUND OF THE INVENTION

### Field of the Invention

This invention relates to a cutting tool for cutting siding and other materials at angles ranging from approximately 0° to approximately 180°. More specifically, this invention relates to a cutting tool including a base, a cutting surface, and a rotatable blade holder which allows a blade to be set to various angles, and a handle connected to a cam to move the blade between an open position and a closed position by rotating the cam.

### Discussion of Related Art

When siding a house, some of the siding must be cut to match the pitch of roof. Various tools are currently used to cut siding to match the pitch, but most are bulky, heavy, require power to be operated, produce large amounts of dust during the cutting process, and/or result in uneven or splintered cuts. As such, there is a need for an improved cutting tool for cutting siding. There is a need or a desire for a portable, non-power operated cutting tool able to cut siding in a predictable and straight fashion without splintering, cracking or similar problems and providing fast, dust-free cutting.

### SUMMARY OF THE INVENTION

The present invention provides a hand-operated cutting tool for cutting siding at a range of angles. The cutting tool is preferably manufactured from durable materials that are capable of withstanding the repeated stress of cutting the materials, such as steel and aluminum.

In an embodiment of this invention, the cutting tool comprises a base with a cutting platform that is rotatably connected to the base. The base preferably includes a guide rail for lining up a length of siding to be cut. The cutting platform preferably includes a first end and a second end, wherein the cutting platform is rotably connected to the base at the first end allowing the second end to slide along the curved rail and be set at an angle to the guide rail ranging from, for example, 20° to 160°.

In an embodiment of this invention, the cutting platform further includes a cutting surface and a pair of supports connected to the cutting surface. The pair of supports extend generally perpendicular to the cutting surface and provide support for a cam. The cam is connected to the pair of supports with an axle that allows the cam to rotate. The cam is also connected to a handle which provides leverage to rotate the cam about the axle. In a preferred embodiment, the cam is a dual-sided cam including a front cam edge and a rear cam edge. The front cam edge and the rear cam edge allows the handle to be pulled towards the user, at a front of the cutting tool, whether the cutting platform is set at an acute angle or at an obtuse angle.

The cutting tool further includes a blade holder with a blade positioned between at least a portion of the cam and a portion of the cutting surface. The blade holder and the blade are movable between an open position and a closed position by pivoting the cam and an increasing radius of either the front cam edge or the rear cam edge forces the blade holder and the blade downward to cut the siding against a blade stop of the cutting surface.

### BRIEF DESCRIPTION OF THE DRAWINGS

These and other objects and features of this invention will be better understood from the following detailed description taken in conjunction with the drawings, wherein:

FIG. 1 is a perspective view of a cutting tool according to one embodiment of this invention with a cutting platform set at a right angle to a guide rail.

FIG. 2 is another perspective view of the cutting tool shown in FIG. 1.

FIG. 3 is a front view of the cutting tool shown in FIG. 1.

FIG. 4 is a side view of the cutting tool shown in FIG. 1.

FIG. 5 is another side view of the cutting tool shown in FIG. 1.

FIG. 6 is a top view of the cutting tool shown in FIG. 1.

FIG. 7 is a perspective view of the cutting tool shown in FIG. 1 with the cutting platform set at an acute angle to the guide rail.

FIG. 8 is a top view of the cutting tool shown in FIG. 7.

FIG. 9 is a perspective view of the cutting tool shown in FIG. 1 with the cutting platform set at an obtuse angle to the guide rail.

FIG. 10 is a top view of the cutting tool as shown in FIG. 9.

FIG. 11 is an exploded assembly view of the cutting tool shown in FIG. 1.

FIG. 12 is enlarged view of the cutting tool shown in FIG. 1 showing a cam and a blade holder with a support removed.

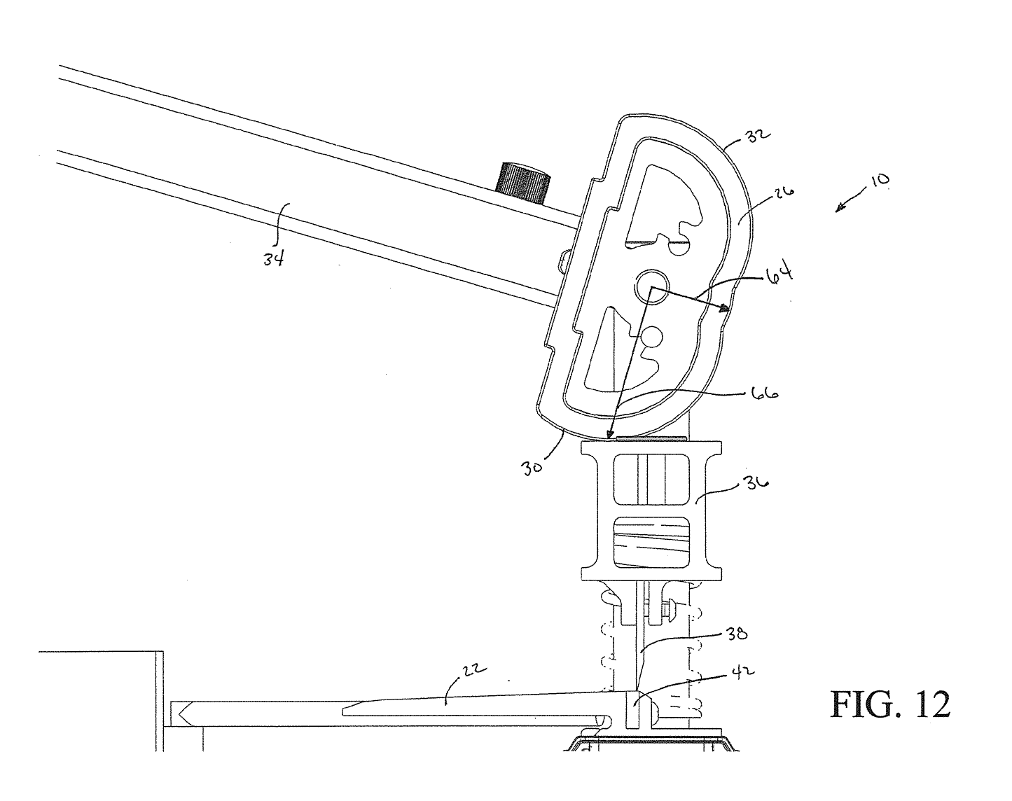

### DESCRIPTION OF THE INVENTION

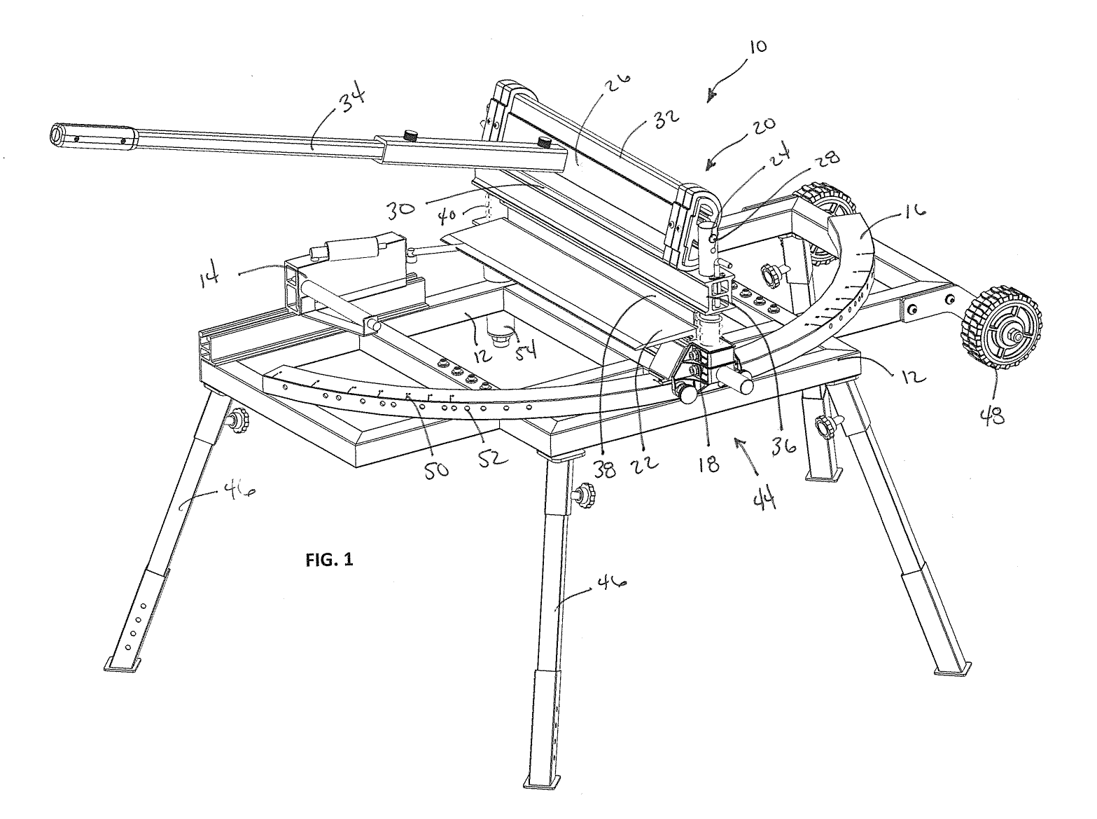

FIG. 1 shows a cutting tool 10 according to an embodiment of this invention. The cutting tool 10 as described is preferably used to cut siding, such as fiber cement siding, fly ash siding, wood siding, and vinyl siding. However, the cutting tool 10 is not limited to these type of siding and may be used to cut other materials, including, but not limited to, flooring, baseboards, trim, and other types of building materials. The cutting tool is preferably manufactured from durable materials that are capable of withstanding the repeated stress of cutting the materials, including, but not limited to, steel and aluminum. In a preferred embodiment, the blade is manufactured from tungsten steel.

The cutting tool 10 of this invention preferably includes a base 12, a curved rail 16 mounted to the base 12, a cutting platform 20 pivotally connected to the base 12 at one end and able to slide along the curved rail 16 at another end, and a blade holder 36 with a blade 38 that is moveable from a starting position to a cutting position to cut the siding.

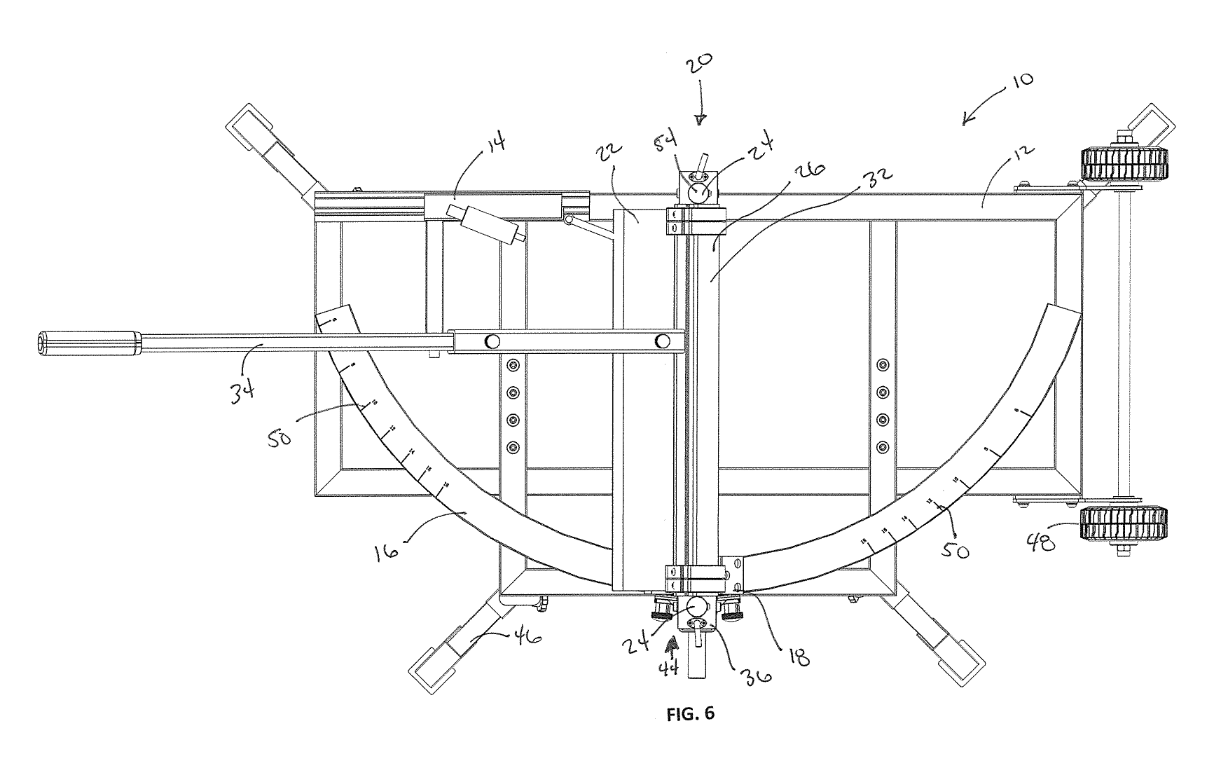

In a preferred embodiment, the base 12 is manufactured from a rigid and durably material capable of withstanding forces generated by cutting the siding. In a preferred embodiment, the base 12 is formed of steel, aluminum, or other similar rigid and durable materials. As best shown in the top views of FIGS. 6 & 8, the base 12 comprises hollow-rectangular tubing arranged as a plurality of rectangular shapes. This design provides a light-weight and solid support that is resistant to deformation and other types of damage from the cutting process. However, the base 12 is not limited to hollow tubing formed as rectangular shapes and may be designed in other ways to provide a light-weight and strong support. In a preferred embodiment, the base 12 of this invention may include a plurality of legs 46 that are adjustable to a plurality of heights and may be removed and otherwise attached to the base 12 to improve the portability of the cutting tool 10. In a preferred embodiment, the base may further include a pair of wheels 48 and a hand grip 72 to improve the portability of the cutting tool 10.

As shown in the figures, the curved rail 16 is mounted to the base 12 with a plurality of threaded connectors. However, the curved rail 16 may be attached using other methods such a weld connection. In a preferred embodiment, the curved rail 16 may include reference markings 50 to identify, for example, cutting angles ranging from 20° to 160°, and/or roof pitches, for example ranging from 4/12 to 18/12. In a preferred embodiment, the curved rail 16 may further include a plurality of apertures 52 for locking the cutting platform 20 in a position relative to the base 12.

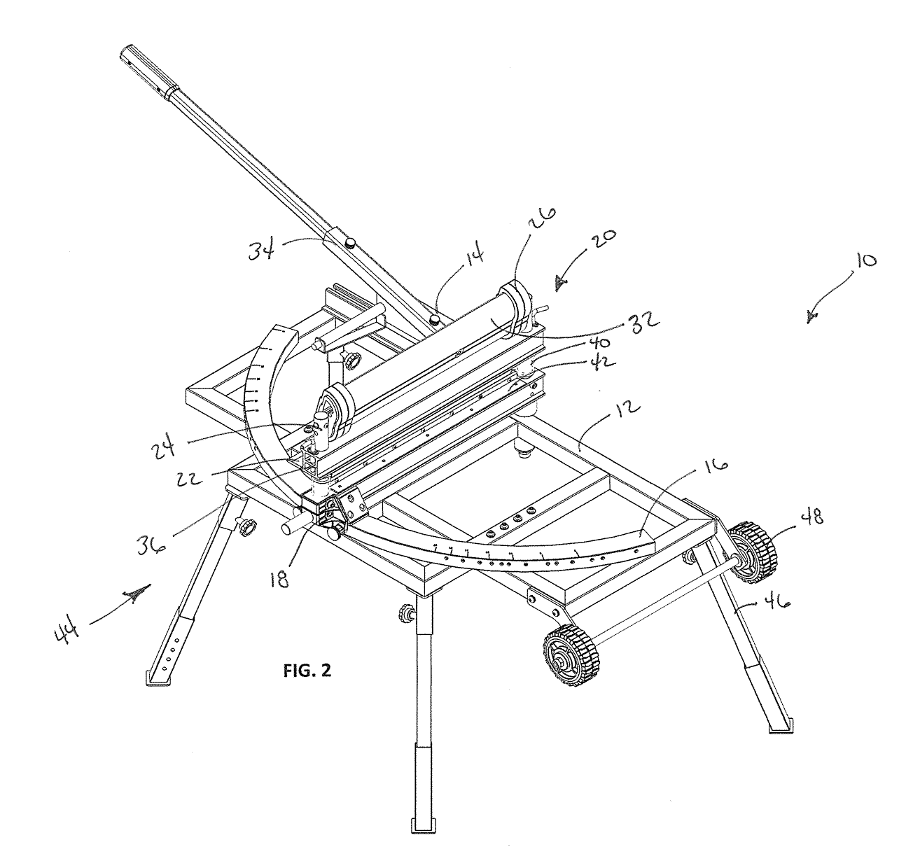

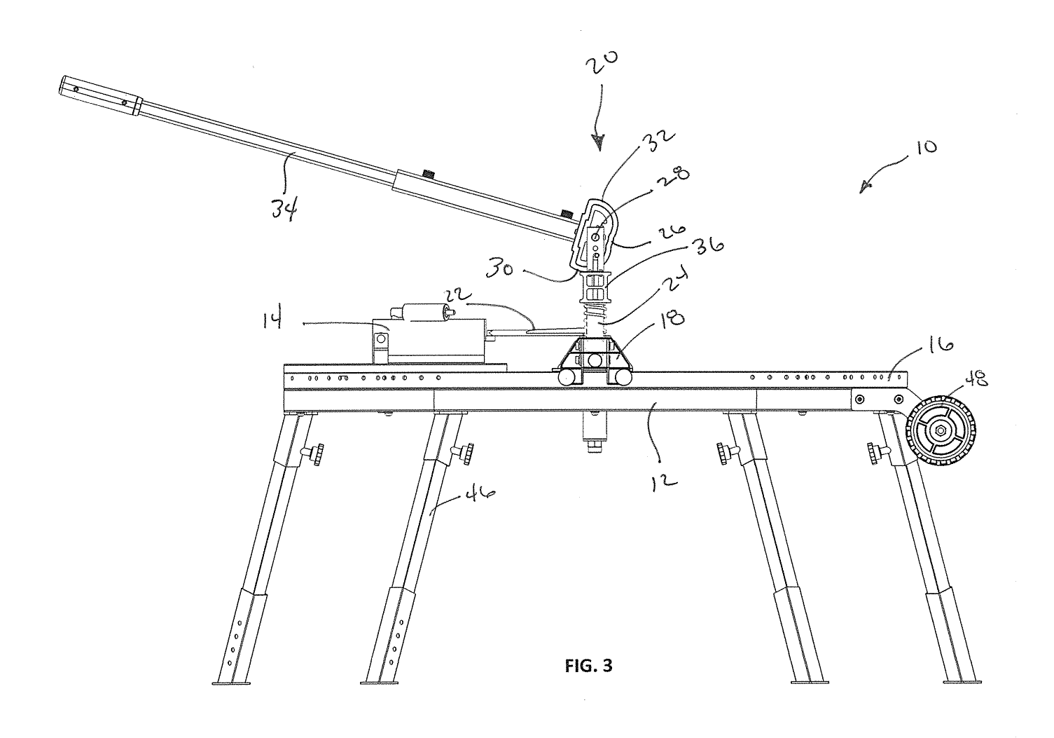

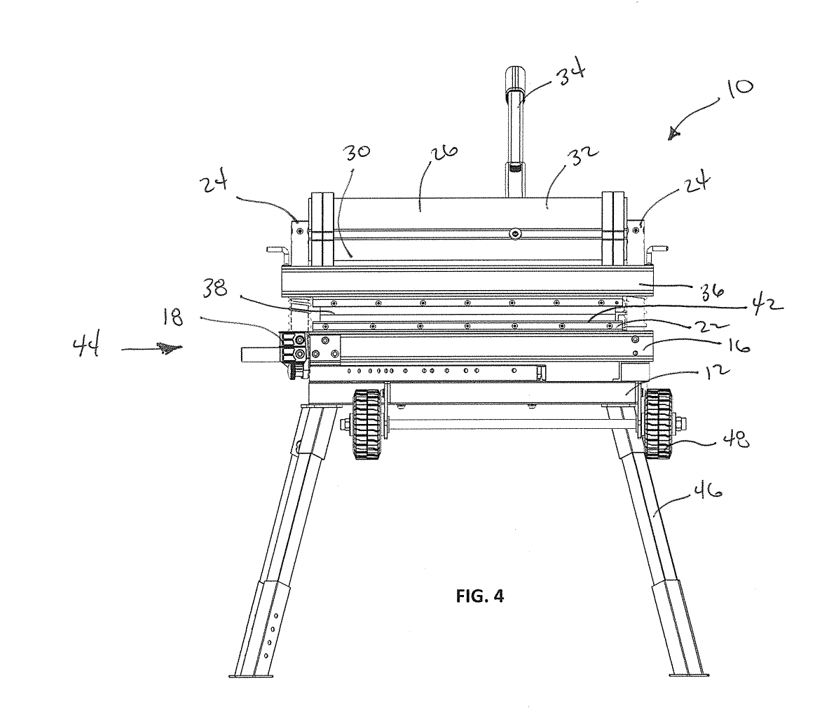

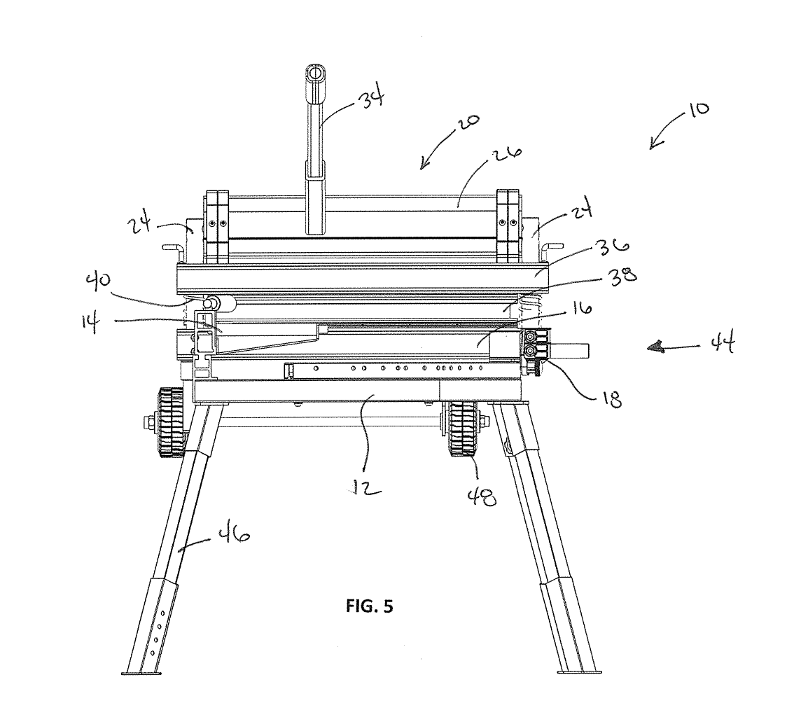

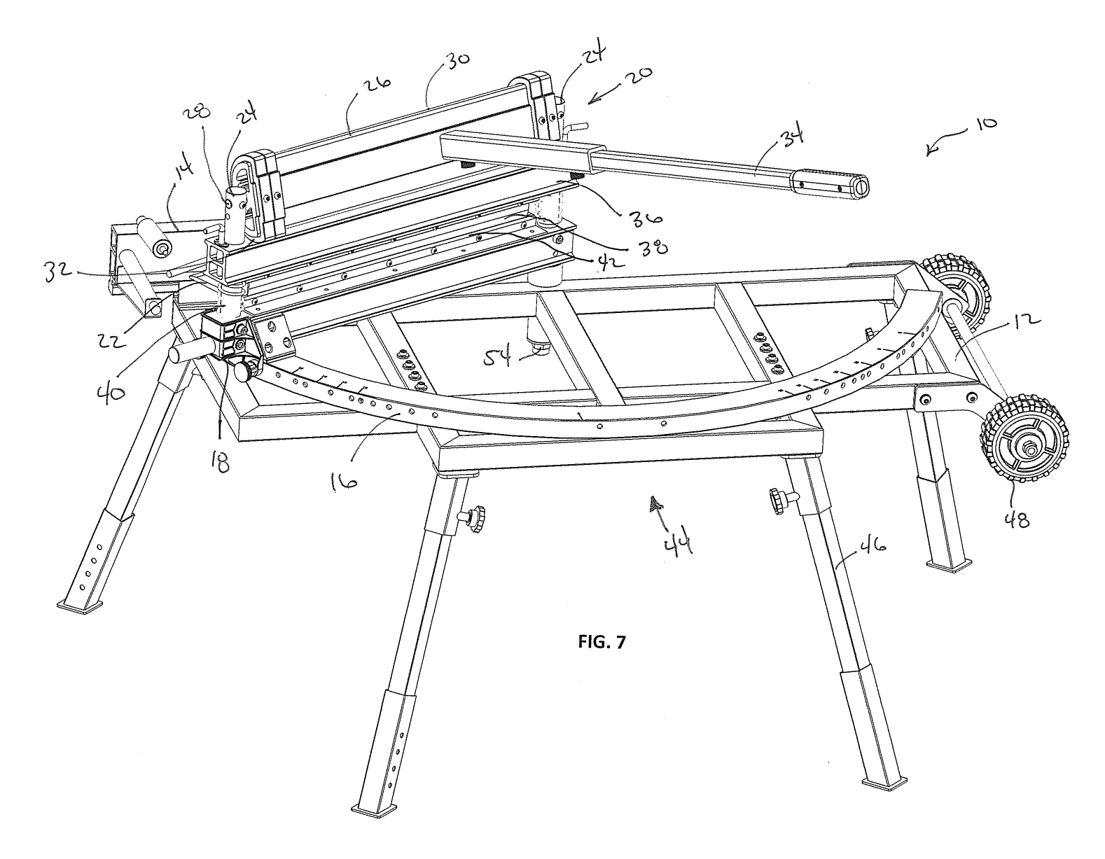

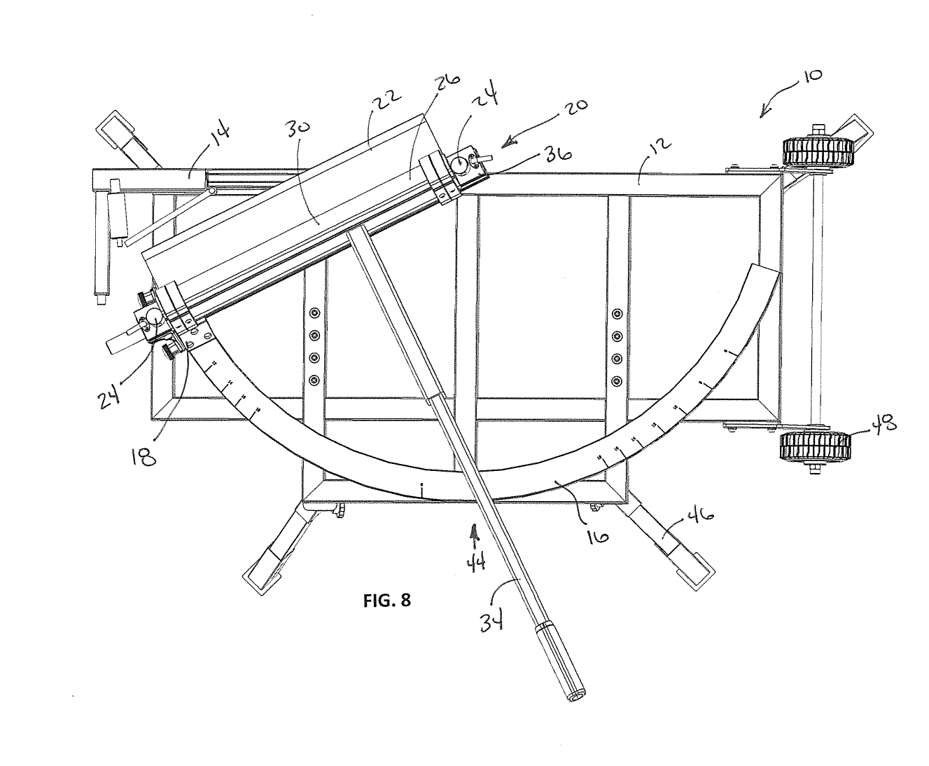

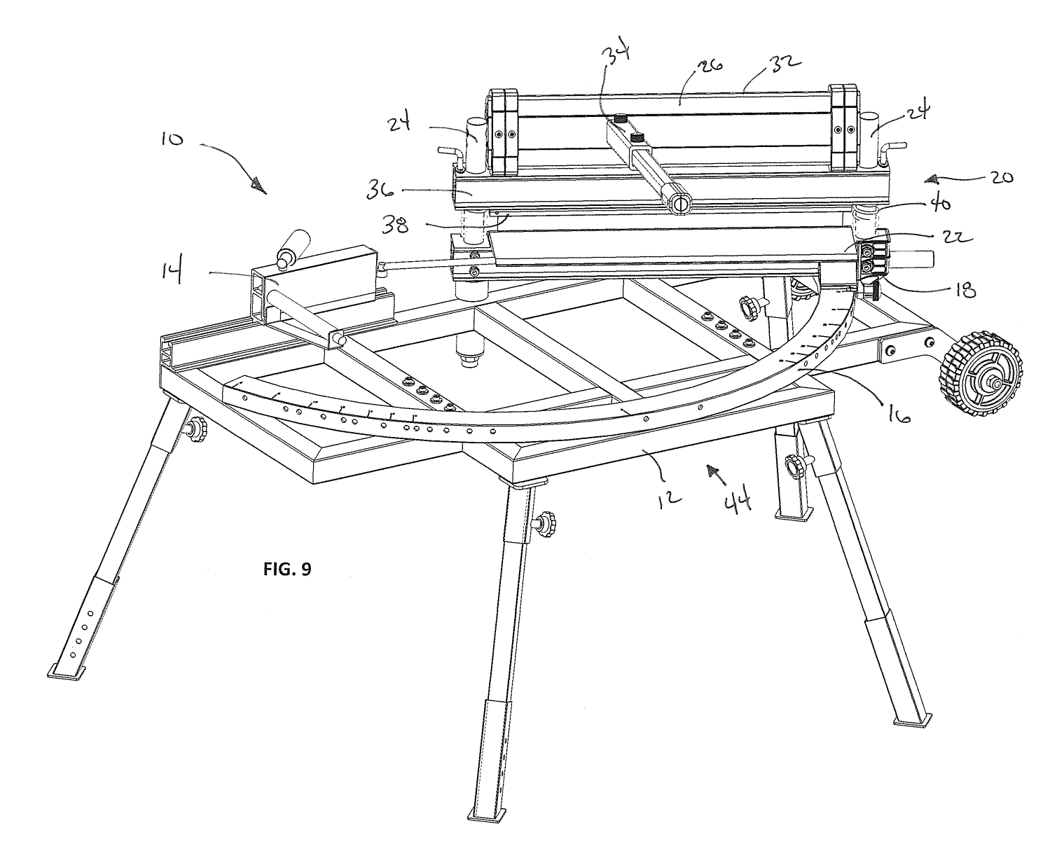

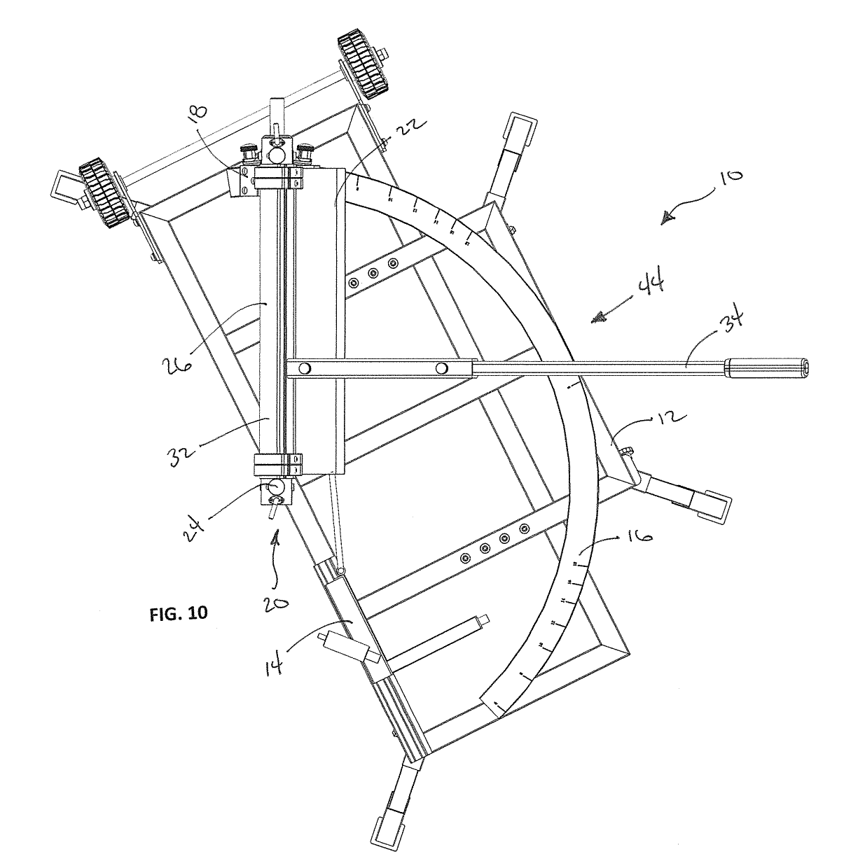

The cutting platform 20 is attached to the base 12 with a rotatable connection 54. More specifically, the cutting platform 20 preferably includes a first end that is connected to the base 12 with the rotatable connection 54 allowing the cutting platform 20 to pivot around the rotatable connection 54. The cutting platform 20 also includes a second end that includes a slider 18 that engages and slides along the curved rail 16 and may be locked into position at a plurality of points along the curved rail 16. As shown in the figures, the cutting platform 20 includes a plurality of locking knobs 56 on the second end that engage with one or more of the apertures 52 on the curved rail 16 to lock cutting platform 20 in a position along the curved rail 16. For example, FIGS. 1-6 show the blade set at a right angle to the guide rail 14 (indicated as 0 on the reference markings), FIGS. 7-8 show the blade set at an acute angle to the guide rail 14 (indicated as a 6 on the reference markings, a pitch of 6/12), and FIGS. 9-10 show the blade set at an obtuse angle to the guide rail 14 (indicated as a 6 on the reference markings, a pitch of 6/12). The cutting platform 20 is also desirably sized to accommodate standard-sized siding with a depth of up to 1 inch and a width of up to 24 inches. However, the cutting platform 20 can be designed to accommodate any desired siding depth and width.

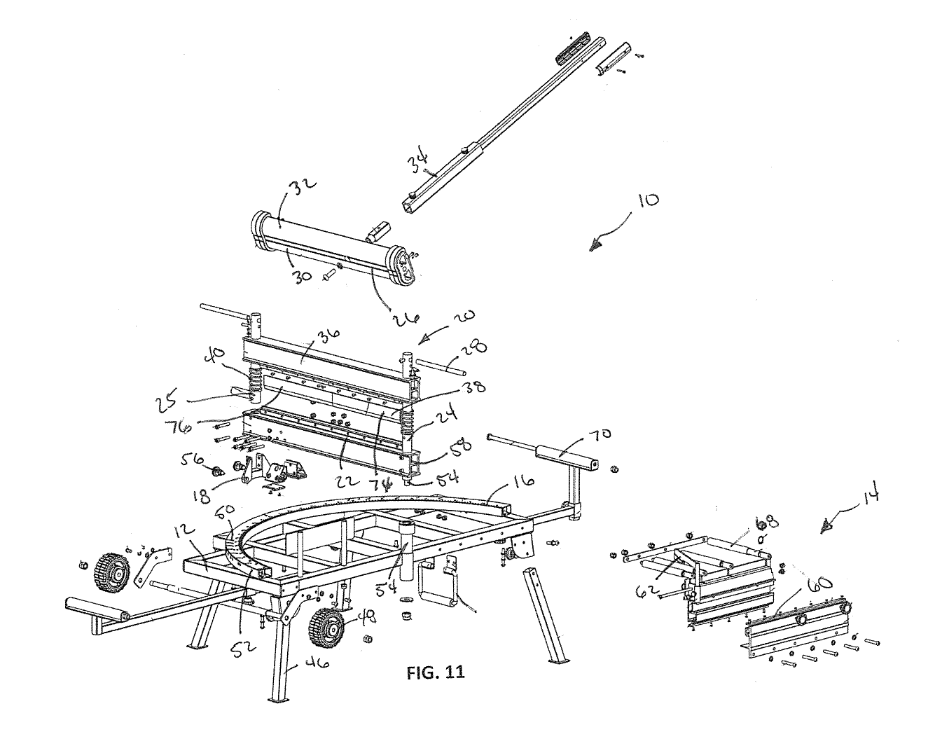

As best shown in the assembly view of FIG. 11, the cutting platform comprises a cutting platform base 58 with a pair of supports 24, 25 that extend from the cutting platform base 58 generally perpendicular to a plane of a cutting surface 22. In a preferred embodiment, the support 24 on the first end of the cutting platform 20 aligns with an axis of rotation for the rotatable connection 54. The support 25 on the second end of the cutting platform 20 is proximate to the slider 18.

As shown in the figures, the cutting platform 20 preferably includes a cutting surface 22 to support at least a portion of the siding that is to be cut. The cutting surface 22 is preferably sized to accommodate standard sizes of siding. The cutting surface 22 may also include a replaceable blade stop 42 to prevent damage to the blade 38 as it contacts the cutting platform 20. In a preferred embodiment, the blade stop 42 is made of nylon or a similar soft material that minimizes damage to the blade.

In a preferred embodiment, a cam 26 is positioned between the pair of supports 24, 25 and over a portion of the cutting surface 22. The cam 26 preferably includes a cam axle 28 that extends through a portion of each of the pair of supports 24, 25 to rotatably connect the cam 26 to the pair of supports 24, 25. The cam 22 further includes a front cam edge 30 and a rear cam edge 32. The front cam edge 30 or the rear cam edge 32 can be used to actuate the blade holder 36 and the blade 38 along the supports 24, 25 from the starting position to the cutting position.

In a preferred embodiment, this invention includes a handle 34 with a proximate end and a distal end. The proximate end of the handle 34 is attached to the cam 26, to provide leverage to a user to rotate the cam 22 either in the direction of the front cam edge 30 or the rear cam edge 32. This attachment can be formed in various ways including, but not limited to, a threaded connection, a welded connection or by integrating the cam and the handle. The distal end preferably includes a hand grip for the user to manually grab or engage. In a preferred embodiment, the handle 34 may be extendible to provide a longer lever for cutting the material. In the figures of this embodiment, the handle comprises a pair of nested square-tubular structures which can be extended by sliding an inner structure out from an outer structure thereby increasing leverage for the user.

In a preferred embodiment of the invention, the cutting tool 10 includes a guide rail 14 connected to the base 12. The guide rail 14 allows a user to position the siding against the guide rail 14 to align the siding to the blade 38. The guide rail 14 preferably mounted to the base 12 on a guide rail track 60 allowing the guide rail 14 to slide to and from the rotatable connection 54 in order to properly support the siding depending on a position of the cutting platform 20. In a preferred embodiment, the guide rail 14 further includes a roller support 68 for supporting and lining up the siding with the blade 38 of the cutting tool. The guide rail 14 may also include a swing holding bar 62 to hold down the siding to be cut. The swing holding bar 62 is particularly useful for holding down shorter pieces of siding. The base 12 may further include one or more extension supporting arms 70 for supporting longer siding.

In a preferred embodiment, the blade holder 36 and the blade 38 are positioned between the pair of supports 24, 25 under at least a portion of the cam 26 and over a portion of the cutting surface 22. In the embodiment shown in the figures, the blade holder including openings that each surround one of the supports 24, 25, to maintain the blade holder 36 and blade 38 in a straight path from the starting position to the cutting position. Actuation of the handle 34 preferably lowers the blade holder 36 and the blade 38 from the starting position to the cutting position.

According to a preferred embodiment, the blade holder 36 and the blade 38 are biased upward into the open position by a spring 40. In the embodiment shown, the spring 40 wraps around the support 24. In an alternative embodiment, the spring 40 may or may not wrap around the support 24. As blade holder 36 travels downward, the spring 40 is compressed to further urge a straight and uniform cut of the blade 38 through the siding.

The cutting tool 10 according to one embodiment of this invention is designed to cut siding at a range of angles to the guide rail 14, ranging from approximately 20° to 160°. To set the angle of the blade 38 to a plane of the guide rail 14, a user releases the lock 56 on the slider 18 and moves the second end of the cutting platform 20 along the curved rail 16 to a desired angle. The user then sets the slider 18 in position by allowing the locking knob 56 to engage one of the apertures 52 on the curved rail 16. For example, FIGS. 1-6 show the cutting platform 20 set at a right angle, FIGS. 7-8 show the cutting platform 20 set at an acute angle, and FIGS. 9-10 show the cutting platform 20 set at an obtuse angle.

In operation, the cutting tool 10 of this invention starts in the open position. In the open position, the spring 40 biases the blade holder 36 upward and the cam 40 contacts the blade holder 36 at a relatively small radius 64, providing space between the blade 38 and the cutting surface 22. A user sets the cutting platform 20 to a desired angle and inserts the siding to be cut onto the cutting surface 22 and through the space between the blade 38 and the cutting surface 22. To cut the siding, the handle 34 is lowered in either direction, rotating the cam 26. By rotating the cam 26, either the front cam edge 30 or the rear cam edge 32 comes in contact with the blade holder 36 forcing the blade holder 36 and the blade 38 downward until the cutting tool 10 is in the closed position with a large radius 66 of the cam 26 contacting blade holder 36, thereby cutting the siding. It should be understood that the front cam edge 30 and the rear cam edge 32 allow a user to remain positioned at a front 44 of the cutting tool 10 and always pull the handle 34 downwards and towards the front of the cutting tool 10. For example, when the cutting tool 10 is set to an acute angle, for example FIG. 7, the handle is pulled toward the user standing at the front 44 and the rear cam edge 32 forces the blade holder 36 and blade 38 downward and through the siding to be cut. Similarly, when the cutting tool 10 is set to an obtuse angle, for example FIG. 9, the handle is also pulled toward the user standing at the front 44 and the front cam edge 30 forces the blade holder 36 and blade 38 downward and through the siding to be cut.

In a preferred embodiment of this invention, the blade 38 is preferably mounted to the blade holder 36 in a manner which allows the blade 38 to be detached, including, but not limited to, a threaded connection and a friction fit. Such a detachable mounting allows the blade 38 to be removed for sharpening and/or repairs. However, the blade 38 can be permanently mounted to the blade holder 36 with a weld, an adhesive connection, a friction fit or other type of connection. Alternatively, the blade 38 can be integrally formed with the blade holder 36. In an embodiment of the invention, the blade 38 may comprise a plurality of blade sections 74, 76 which may be replaced individually due to wear. For example, the blade 38 generally wears faster near the rotatable connection 54 as such, in one embodiment, the blade 38 comprises a pair of blade sections 74, 76 allowing the blade section 74 near the rotatable connection 54 to be replaced or sharpened as necessary without requiring replacement of the other blade section 76.

In an alternative embodiment of this invention, the cutting tool 10 may include a means for lining up the material to be cut with the blade, for example, the cutting tool 10 can include a laser guide for lining up the material to be cut.

While in the foregoing specification this invention has been described in relation to certain preferred embodiments thereof, and many details have been set forth for purpose of illustration, it will be apparent to those skilled in the art that the material cutter is susceptible to additional embodiments and that certain of the details described herein can be varied considerably without departing from the basic principles of the invention.

What is claimed is:

1. A cutting tool comprising:
a base including a guide rail and a curved rail;
a cutting platform including a first end and a second end, wherein the cutting platform is notably connected to the base at the first end allowing the second end of the cutting platform to be set at a plurality of angles to the guide rail, and wherein the cutting platform further comprises:
a cutting surface;
a pair of supports connected to the cutting surface;
a cam including a small radius and a larger radius positioned between the pair of supports, the cam connected to the pair of supports with an axle, wherein the axle allows the cam to rotate;
a handle connected to the cam, wherein the handle provides leverage to rotate the cam about the axle; and
a blade holder with a blade positioned between at least a portion of the cam and a portion of the cutting surface, wherein the blade holder and the blade are movable between a starting position and a cutting position by rotating the cam to force the blade holder and the blade downward along the pair of supports to cut material placed between the pair of supports.

2. The cutting tool of claim 1, wherein the cam further comprises a front cam edge and a rear cam edge.

3. The cutting tool of claim 1, wherein the cutting platform further includes a slider positioned on the curved rail.

4. The cutting tool of claim 3, wherein the slider includes a locking knob engageable with one or more apertures on the curved rail to lock the cutting platform in a position along the curved rail.

5. The cutting tool of claim 1, wherein the cutting platform is adjustable to cut roof pitch angles ranging from 4/12 to 18/12.

6. The cutting tool of claim 1, wherein the cutting platform can be set to a plurality of angles to the guide rail ranging from 20° to 160°.

7. The cutting tool of claim 1, wherein the guide rail includes a roller for supporting the material to be cut.

8. The cutting tool of claim 7, wherein the guide rail is positioned on a guide rail track for adjusting a position of the guide rail relative to the first end of the cutting platform.

9. The cutting tool of claim 1, wherein the blade comprises a plurality of blade sections.

10. A cutting tool comprising:
a base including a guide rail and a curved rail;
a cutting platform pivotally connected to the base, wherein the cutting platform includes a cutting surface and a pair of supports extending perpendicular to the cutting platform;
a cam positioned between the pair of supports and connected to the pair of supports with an axle, the cam including a front cam surface with a gradually increasing radius and an rear cam surface with a gradually increasing radius;
a blade holder with a blade positioned between at least a portion of the cam and a portion of the cutting surface, wherein the blade holder and the blade are movable between a starting position and a cutting position by rotating the cam; and
wherein a first end of the cutting platform swivels about the base and a second end slides along the curved rail to be set at an angle to the guide rail.

11. The cutting tool of claim 10, further comprising a handle connected to the cam, wherein the handle provides leverage to rotate the cam about the axle.

12. The cutting tool of claim 10, wherein the cutting platform further includes a slider positioned on the curved rail.

13. The cutting tool of claim 12, wherein the slider includes a locking knob engageable with one or more apertures on the curved rail to lock cutting platform in a position along the curved rail.

14. The cutting tool of claim 13, wherein the cutting platform is adjustable to a plurality of angles to the guide rail ranging from 20° to 160°.

15. The cutting tool of claim 10, further comprising a spring positioned between the blade holder and the cutting platform base, the spring biasing the blade holder in the starting position.

16. The cutting tool of claim 10, wherein the guide rail includes a roller for supporting the material to be cut.

17. The cutting tool of claim 10, wherein the guide rail is positioned on a guide rail track for adjusting a position of the guide rail relative to the first end of the cutting platform.

18. The cutting tool of claim 10, wherein the blade comprises a plurality of blade sections.
